(19) United States
(12) Patent Application Publication
(10) Pub. No.: US 2002/0145791 A1
(43) Pub. Date: Oct. 10, 2002

(54) Optical component having a reduced thermal sensitivity

(76) Inventors: Lee Cheng, Pasadena, CA (US); Chi Wu, San Marino, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/055,706

(22) Filed: Jan. 23, 2002

Related U.S. Application Data
(60) Provisional application No. 60/263,609, filed on Jan. 23, 2001.

(51) Int. Cl. G02F 1/01

(52) U.S. Cl. 359/288

(57) ABSTRACT

An optical component is disclosed. The optical component includes a light signal carrying region positioned between secondary regions. The component also includes a thermal conductor positioned over the light signal carrying region and at least a portion of the secondary regions. The thermal conductor includes one or more nanotubules. In some instances, the nanotubules are formed by applying microwaves to a material such as carbon.

### RELATED APPLICATION

This application claims priority from U.S. Provisional Patent Application titled “OPTICAL COMPONENT HAVING A REDUCED THERMAL SENSITIVITY”, Ser. No. 60/263,609, filed Jan. 23, 2001.

### BACKGROUND

1. Field of the Invention

The invention relates to one or more optical networking components. In particular, the invention relates to optical networking components having a reduced thermal sensitivity.

2. Background of the Invention

Optical networking devices can include one or more optical components such as filters, switches, multiplexers, demultiplexers and attenuators. The performance of these optical components is often impacted by temperature sensitivity. For instance, demultiplexers are often designed to produce a particular wavelength of light on a particular output waveguide. However, changes in the temperature of the demultiplexer can cause the intensity of the particular wavelength of light on the output waveguide to decrease or to be lost altogether. Further, large temperature fluctuations can cause undesired wavelengths of light to appear on the output waveguide. As a result, the performance of the demultiplexer is a function of temperature. For these reasons, there is need for optical components having a reduced thermal sensitivity.

### SUMMARY OF THE INVENTION

The invention relates to an optical component for carrying light signals. The optical component includes a light signal carrying region adjacent to at least one secondary region. A thermal conductor is positioned adjacent to the light signal carrying region and at least one secondary region. In some instances, the thermal conductor includes one or more nanotubules.

In another embodiment, the optical component includes a ridge adjacent to at least one secondary region. The ridge at least partially defines the light signal carrying region. A thermal insulator is positioned adjacent to the ridge. In some instances, a thermal conductor is positioned adjacent to the thermal insulator and at least one secondary region.

The invention also relates to a method for forming an optical component. The method includes forming a waveguide adjacent to one or more secondary regions. The method also includes forming a thermal conductor adjacent to one or more secondary regions. In some instances, forming a thermal conductor includes forming nanotubules adjacent to one or more secondary regions.

In one embodiment, forming nanotubules includes applying microwaves to a material such as carbon.

### BRIEF DESCRIPTION OF THE FIGURES

FIG. 1A is a perspective view of a portion of an optical component including a waveguide between secondary regions. The component includes a thermal conductor positioned over the waveguide and the secondary regions.

FIG. 1B is a cross section of the component shown in FIG. 1A taken at the line labeled A.

FIG. 2A illustrates an optical component having a thermal conductor positioned adjacent to a light barrier.

FIG. 2B illustrates an optical component having a thermal conductor positioned adjacent to a substrate.

FIGS. 3A through FIG. 3C illustrate optical components having a thermal insulator positioned between a waveguide and a thermal conductor.

FIG. 4A illustrates an optical component having a light barrier with a light transmitting medium positioned adjacent to the sides of the light barrier. A thermal conductor is positioned over a waveguide.

FIG. 4B illustrates the component of FIG. 4A with a thermal insulator positioned between a thermal conductor and a waveguide.

FIG. 5 illustrates an optical component having a thermal insulator that extends past the sides of a light barrier.

FIG. 6A illustrates an optical component having a waveguide adjacent to a secondary region. A thermal insulator is extends away from a side of the waveguide toward a secondary region.

FIG. 6B illustrates the optical component of FIG. 6A having a light barrier with a light transmitting medium positioned adjacent to the sides of the light barrier.

FIG. 7A illustrates an optical component having a plurality of waveguides. A thermal conductor extends over more than one of the waveguides.

FIG. 7B illustrates an optical component having a plurality of waveguides. Each waveguide is associated with a different thermal conductor.

FIGS. 8A through 8C illustrate a method of forming a thermal conductor on an optical component.

FIGS. 9A though 9F illustrate another embodiment of a method of forming a thermal conductor on an optical component.

FIGS. 10A though 10C illustrate another embodiment of a method of forming a thermal conductor on an optical component.

### DETAILED DESCRIPTION OF THE PREFERRED EMBODIMENT

The invention also relates to an optical component having a waveguide positioned between secondary regions. A thermal conductor is formed adjacent to the waveguide and the secondary regions. The thermal conductor serves to carry heat away from the waveguide towards the secondary regions. The heat is then conducted through the secondary regions instead of through the waveguide. Accordingly, the thermal conductor reduces the impact of temperature variations on the waveguide.

In some instances, the thermal conductor includes one or more nanotubules and the waveguide includes silicon or silica. Nanotubules do not conduct light but have a thermal conductivity much greater than silicon or silica. The increased thermal conductivity of the nanotubules as compared to the silicon or silica provides effective conduction of heat away from the waveguide.

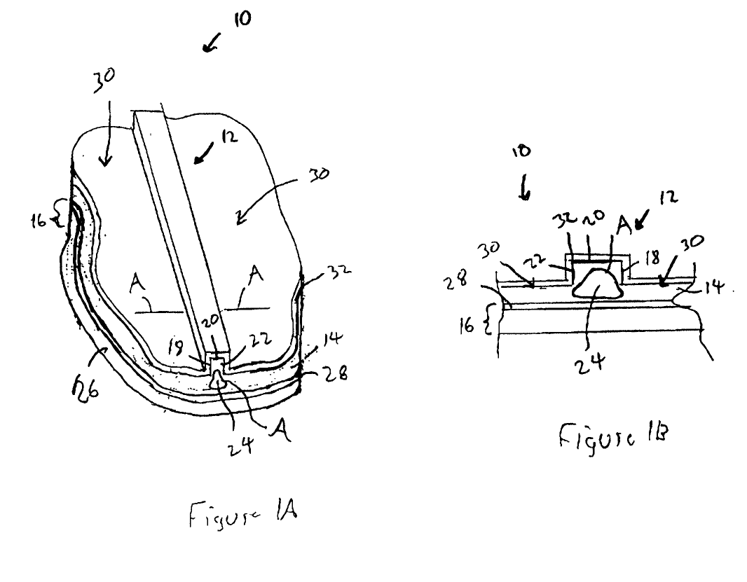

FIG. 1A is a perspective view of a portion of an optical component 10 including a waveguide 12. FIG. 1B is a cross section of the component 10 shown in FIG. 1A taken at the line labeled A. Although a single waveguide 12 is shown, the component 10 can include two or more waveguides 12.

The component 10 includes a first light transmitting medium 14 over a base 16. Suitable light transmitting media include, but are not limited to, silica and silicon. The first light transmitting medium 14 is formed into a ridge 18 having a top 20 and sides 22. The ridge 18 defines a portion of the light signal carrying region 24 of the waveguide 12. The profile of a light signal being carried in the light signal carrying region 24 is illustrated by the line labeled A in FIG. 1B.

The base 16 can include a substrate 26. Suitable substrates 26 include, but are not limited to, silicon. The base 16 can also include a light barrier 28 positioned between the first light transmitting medium 14 and the substrate 26. The light barrier 28 is configured to reflect light from the light signal carrying region 24 back into the light signal carrying region 24. As a result, the light barrier 28 also defines a portion of the light signal carrying region 24.

Suitable light barriers 28 include material having reflective properties such as metals. Alternatively, the light barrier 28 can be a material with a different index of refraction than the first light transmitting medium 14. The change in the index of refraction can cause the reflection of light from the light signal carrying region 24 back into the light signal carrying region 24. A suitable light barrier 28 would be silica when the light carrying medium and the substrate 26 are silicon. Another suitable light barrier 28 would be air or another gas when the light carrying medium is silica and the substrate 26 is silicon.

A secondary region 30 is positioned adjacent to the light signal carrying region 24 of the waveguide 12. The secondary region 30 is the region of the component 10 adjacent to the region where the light signals are carried. The secondary region 30 on one side of the waveguide 12 can be different than the secondary region 30 on the other side of the waveguide 12. Additionally, the waveguide 12 may be positioned adjacent to a single secondary region 30 as would occur when the waveguide 12 is positioned at the edge of the component 10.

A thermal conductor 32 is positioned over the waveguide 12 and the secondary regions 30. A suitable thermal conductor 32 includes, but is not limited to, nanotubules. Because nanotubules have a thermal conductivity that is higher than the thermal conductivity of the first light transmitting medium 14, thermal energy is more readily conducted through the thermal conductor 32 than through the waveguide 12.

The position of the thermal conductor 32 relative to the waveguide 12 serves to conduct thermal energy away from the waveguide 12 and toward the secondary regions 30 where light signals are not carried. For instance, when the thermal energy over the waveguide 12 increases, the thermal energy is conducted through the thermal conductor 32 to the secondary region 30. This thermal energy can be conducted through the secondary region 30 instead of through the waveguide 12. Because useful light signals are not carried in the secondary regions 30 where the energy is conducted, the thermal energy conducted through the secondary regions 30 does not affect the light signals. As a result, the component 10 according to the present invention has a reduced thermal sensitivity.

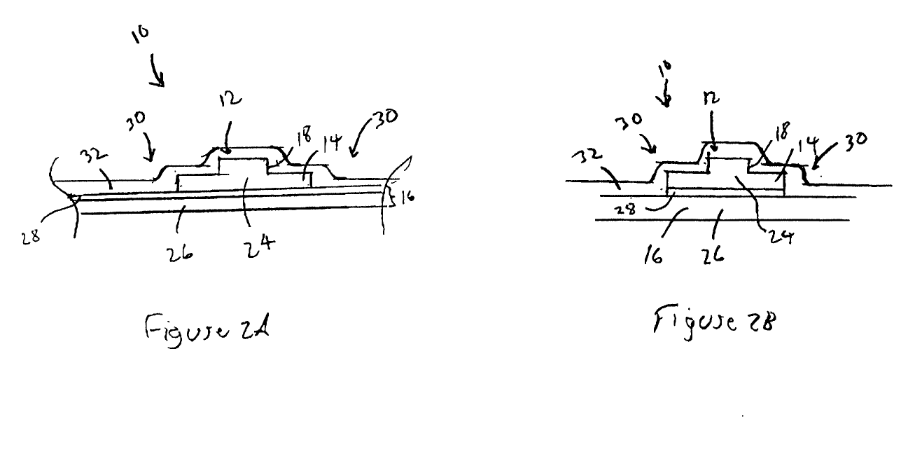

The thermal conductor 32 can be in contact with the light barrier 28 in the secondary region 30 as shown in FIG. 2A or in contact with the substrate 26 as shown in FIG. 2B. These arrangements can further reduce the thermal sensitivity of the optical component 10. For instances, the component 10 shown in FIG. 2B can have a reduced thermal sensitivity when the substrate 26 is a silicon substrate 26 and the light barrier 28 is silica. The reduced sensitivity results from the thermal conductivity of silicon being approximately ten times the thermal conductivity of silica. Hence, thermal energy is more readily conducted from the thermal conductor 32 through the substrate 26 than would occur from the thermal conductor 32 through the light barrier 28.

The first light transmitting medium 14 includes lateral sides 33 extending upward from the light barrier 28 or from the substrate 26 in order to provide contact between the thermal conductor 32 and the light barrier 28 or between the thermal conductor 32 and the substrate 26. The lateral sides 33 of the first light transmitting medium 14 are positioned far enough from the ridge 18 that the fundamental mode of the light signals traveling through the waveguide 12 are not affected. When the lateral sides 33 are positioned coincident with the perimeter of the fundamental mode, the lateral sides 33 define the intersection of the light signal carrying region 24 and the secondary regions 30. When the lateral sides 33 are positioned outside of the fundamental mode, the lateral sides 33 are positioned in the secondary regions 30.

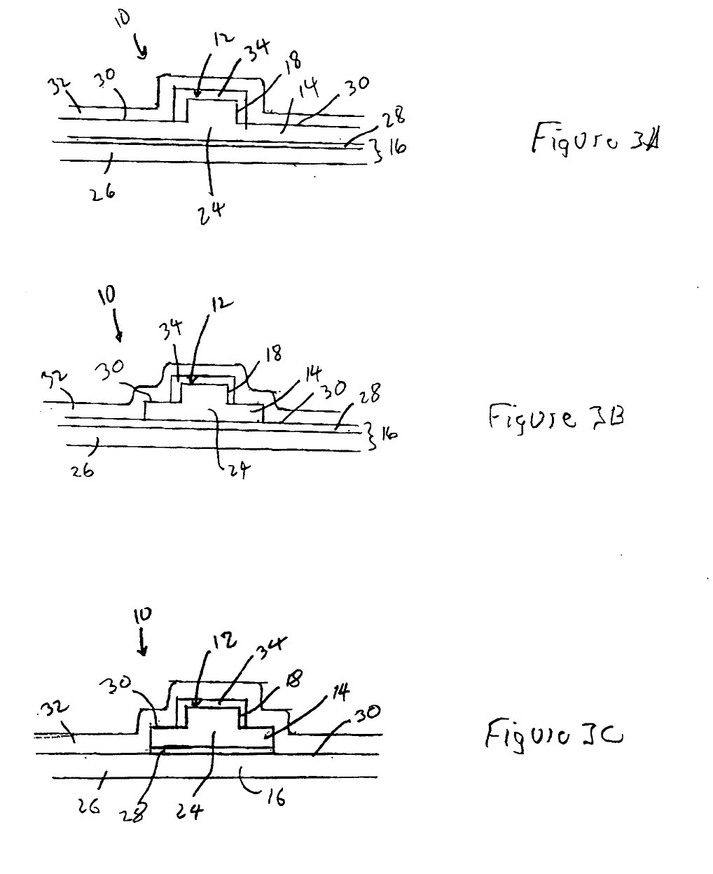

A thermal insulator 34 can be positioned between the waveguide 12 and the thermal conductor 32 as illustrated in FIG. 3A through FIG. 3C. The thermal insulator 34 is illustrated as being positioned adjacent to the sides 22 of the ridge 18 and the top 20 of the ridge 18; however, the thermal insulator 34 can be positioned adjacent to the side 22 of the ridge 18 or the top 20 of the ridge 18. Additionally, the light insulator can be positioned adjacent to a portion of one or more of the secondary regions 30.

The thermal conductor 32 has a thermal conductivity that is higher than the thermal insulator 34. Accordingly, thermal energy is more readily conducted through the thermal conductor 32 than through the thermal insulator 34. In some instances, the thermal conductivity of the thermal conductor 32 is more than 1.2 times the thermal conductivity of the thermal insulator 34, more than 1.6 times the thermal conductivity of the thermal insulator 34, more than 2 times the thermal conductivity of the thermal insulator 34 or more than 4 times the thermal conductivity of the thermal insulator 34. Suitable thermal insulators 34 include, but are not limited to, silica, SiNx, SiONx, TiOx, TaOx, SiCOH, porous silicon or porous SiO₂. In some instances, the thermal insulators 34 have a thermal conductivity of less than about 0.13, 0.5, 1.0, 1.4, 2.2, 3.0, 3.5 or 4.0 W/(cmK) at about room temperature.

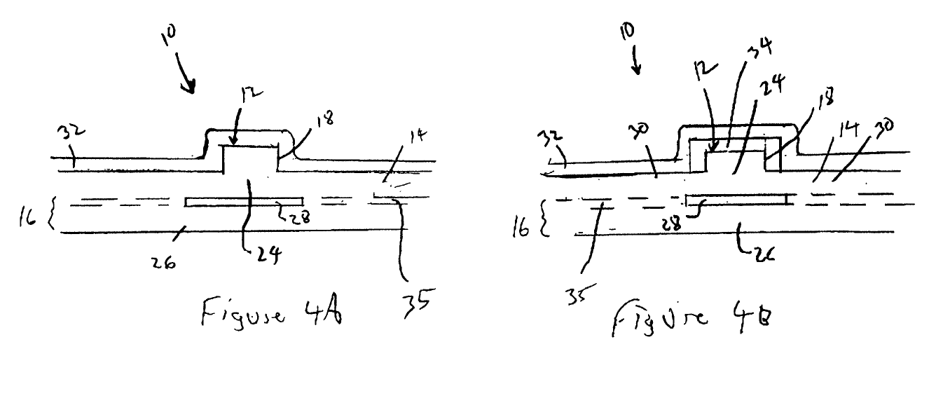

The light barrier 28 can be continuous under the entire optical component 10 as shown in FIGS. 1B. Alternatively, a second light transmitting medium 35 can be formed adjacent to one or more sides of the light barrier 28 as shown in FIG. 4A or FIG. 4B. In some instances, the second light transmitting medium 35 is the same as the first light transmitting medium 14.

A second light transmitting medium 35 positioned adjacent to one or more sides of light barrier 28 can further reduce the thermal sensitivity of the optical component 10. For instance, the light barrier 28 can be constructed from silica while the second light transmitting medium 35 is silicon. The thermal conductivity of silicon is approximately ten times the thermal conductivity of silicon dioxide. Hence, thermal energy is more readily conducted through the secondary regions 30 than through the light signal carrying region 24.

In some instances, the width of the light barrier 28 is larger than 200% of the width of the ridge 18 base. In other instances, the width of the light barrier 28 is less than 200% of the ridge 18 base width, less than 150% of the ridge 18 base width, less than 140% of the ridge 18 base width, less than 130% of the ridge 18 base width, less than 120% of the ridge 18 base width, less than 110% of the ridge 18 base width, less than 100% of the ridge 18 base width. The invention can be used with other waveguide 12 types. When a light barrier 28 is employed with another type of waveguide 12, the light barrier 28 can have the same dimensional relationships to the width of the waveguide 12 that is employed.

The substrate 26, the first light transmitting medium 14 and the second light transmitting medium 35 can be formed of the same or different materials. For instance, the substrate 26, the first light transmitting medium 14 and the second light transmitting medium 35 can all be silicon while the light barrier 28 is air or silica. Alternatively, the substrate 26 and the second light transmitting medium 35 can be silicon and the first light transmitting medium 14 can be silica, while the light barrier 28 is air.

In other embodiments, the substrate 26 can be silicon, the first light transmitting medium 14 can be GaAs, InP, SiGe, LiNbO3 or silicon and the second light transmitting medium 35 can be GaAs or InP, or SiGe, or LiNbO3. The use of GaAs or InP allow the component 10 to be used for high speed applications.

Other suitable materials for the first light transmitting medium 14, the second light transmitting medium 35, the light barrier 28 and the substrate 26 include, but are not limited to, GaAs and its compounds, such as AlGaAs; InP and its compounds, such as InGaAsP, InAlAsP; silicon and its compounds, such as SiGe, SiC, SiGeC, SiN, SiGaN; LiNbO3 and other refractive materials; silica, SiONx, SiNx, low dielectric constants material, such as SiCOH; polymer material; and air. When the first light transmitting medium 14 is Silicon, GaAs or InP, the light barrier 28 could be SiO2, SiNx, SiONx, or air.

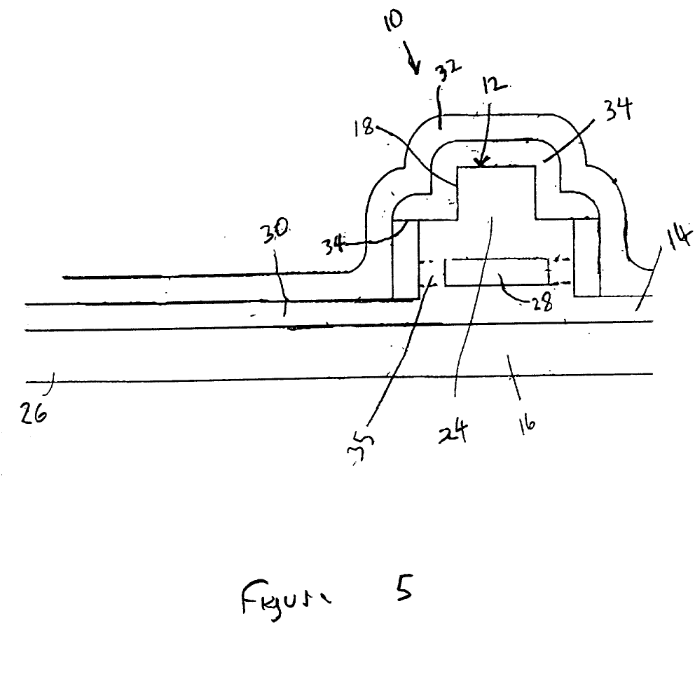

The thermal insulator 34 can extend below the level of the light barrier 28 as shown in FIG. 5. This arrangement increases the portion of the light signal carrying region 24 that is adjacent to a thermal insulator 34 because the entire side of the light signal carrying region 24 is positioned adjacent to the thermal insulator 34.

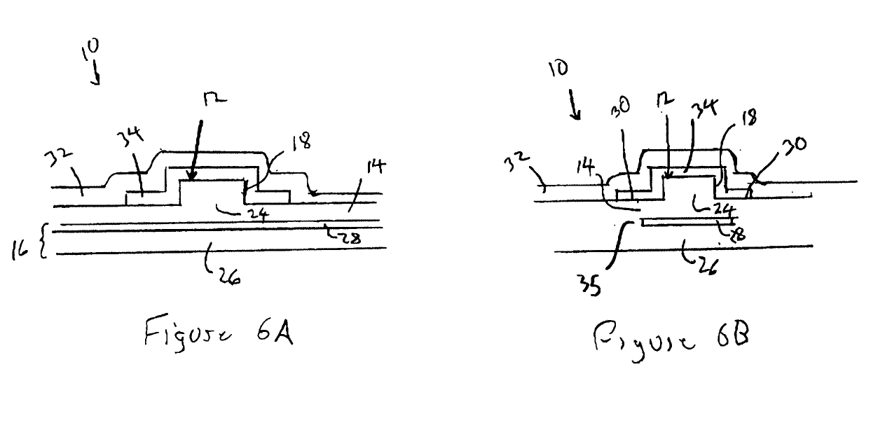

The thermal insulator 34 can extend away from the sides 22 of the ridge 18 as shown in FIG. 6A. In some instances, the thermal insulator 34 can extend over all or a portion of the secondary region 30. The thermal insulator 34 can extend beyond the width of a light barrier 28 as shown in FIG. 6B. Extending the thermal conductor 32 away from the sides 22 of the ridge 18 extends the region of the component 10 that is protected from thermal variations.

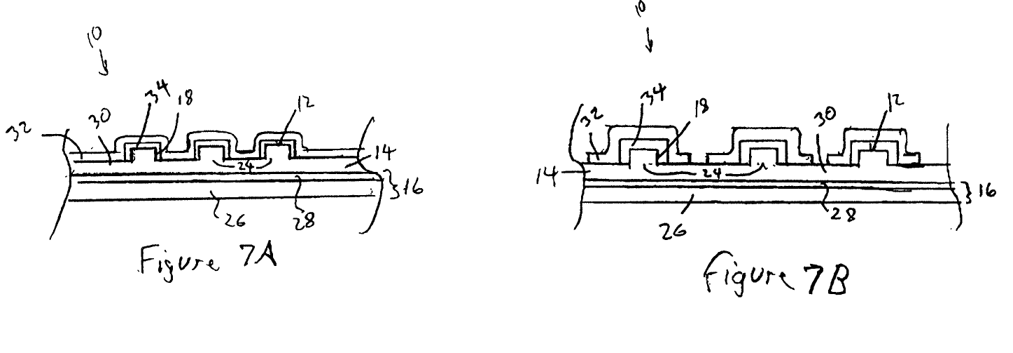

The component 10 can be scaled to include two or more waveguides 12 as shown in FIG. 7A. The thermal conductor 32 extends over each of the waveguides 12 and a different thermal insulator 34 is associated with each waveguide 12. Alternatively, each waveguide 12 can be associated with a different thermal conductor 32 as illustrated in FIG. 7B. The use of different thermal conductors 32 can reduce the influence of thermal energy changes to one waveguide 12 on adjacent waveguides 12.

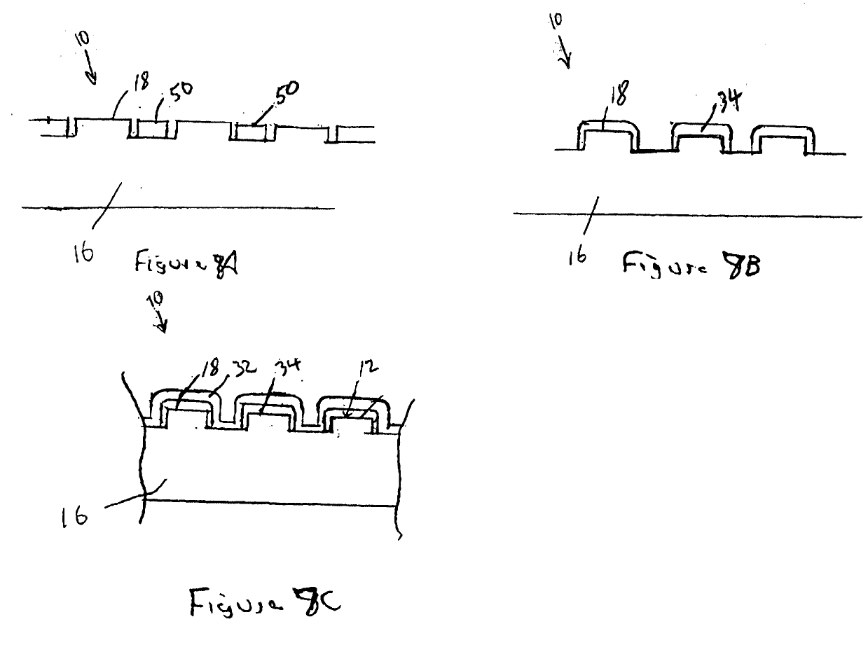

FIG. 8A through FIG. 8C illustrate methods for adding a thermal insulator 34 and a thermal conductor 32 to a base 16. Although the illustrated method shows application of a thermal insulator 34 and a thermal conductor 32 to an optical component 10, the method is easily adapted for application of only a thermal conductor 32 or only a thermal insulator 34 to a base 16.

An outline of a base 16 having three waveguides 12 is illustrated in FIG. 8A. The substrate 26 and light barriers 28 are not illustrated. The base 16 of FIG. 8A can be formed according a variety of available methods. Example methods for forming the base 16 are disclosed in U.S. Patent application serial number (not yet assigned); entitled “Optical Component 10 Having a Reduced Thermal Sensitivity”; filed Nov. 28, 2000; and incorporated herein in its entirety.

A mask 50 is formed adjacent to and spaced apart from the ridges 18. The mask 50 is formed such that the sides 22 and top 20 of the ridges 18 remain exposed. A suitable mask 50 includes, but is not limited to, a photo mask 50. A thermal insulator 34 such as silica is formed adjacent to the exposed portions of the component 10 and the mask 50 removed to provide the component 10 illustrated in FIG. 8B. A suitable method for forming silica includes, but is not limited to, plasma enhanced chemical vapor deposition (PECVD), low pressure chemical vapor deposition (LPCVD), sputtering evaporating and thermal oxidation.

A thermal conductor 32, such as a layer of nanotubules, is then formed adjacent to the secondary regions 30 and the thermal insulator 34 to provide the component 10 illustrated in FIG. 8C. A suitable method for forming a thermal conductor 32 that includes nanotubules includes forming a layer of carbon over the component 10. The component 10 is then exposed to a level of microwaves sufficient to convert the carbon to one or more nanotubules. Unconverted carbon can optionally be removed from the component 10 so the nanotubules remain on the optical component 10. Because silica and silicon are largely invisible to microwave energy, the microwave energy does not substantially affect any silicon or silica in the optical component 10. As a result, this method does not adversely affect the silicon or silica in the optical component 10.

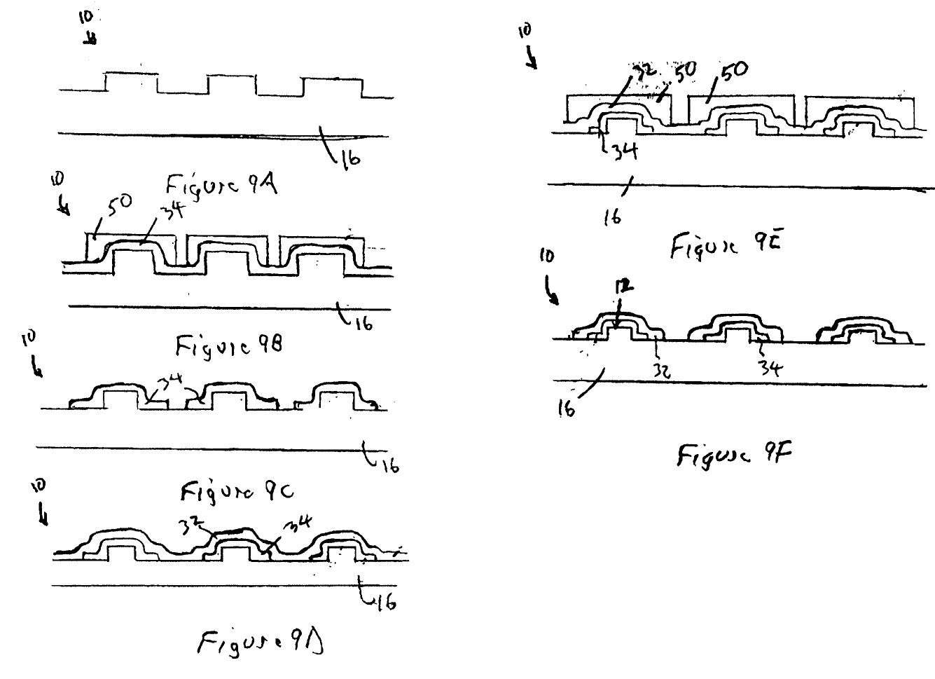

FIG. 9A through FIG. 9F illustrate another method of forming a thermal insulator 34 and a thermal conductor 32 on the component 10. Although the illustrated method shows application of a thermal insulator 34 and a thermal conductor 32 to an optical component 10, the method is easily adapted for application of only a thermal conductor 32 or only a thermal insulator 34 to a base 16.

An outline of a component 10 having three waveguides 12 is illustrated in FIG. 9A. The substrate 26 and light barriers 28 are not illustrated. A thermal insulator 34 such as silica is formed over the component 10 as illustrated in FIG. 9B. The thermal insulator 34 can be formed with a deposition technique such as PECVD, LPCVD, sputtering, evaporation or thermal oxidation. A mask 50 is formed over the regions of the component 10 where the thermal insulator 34 are to be formed as shown in FIG. 9B. A suitable mask 50 includes, but is not limited to, a photo mask 50.

The exposed regions of the thermal insulator 34 are etched and the mask 50 removed to provide the optical component 10 illustrated in FIG. 9C. The remaining thermal insulator 34 extends away from the sides 22 of the ridge 18. A thermal conductor 32 is formed over the component 10 as shown in FIG. 9D. A suitable thermal conductor 32 includes nanotubules. A suitable method for forming a thermal conductor 32 that includes nanotubules includes forming a layer of carbon over the component 10. The component 10 is then exposed to a level of microwaves sufficient to convert the carbon to one or more nanotubules. Unconverted carbon can optionally be removed from the component 10 so the nanotubules remain on the optical component 10. The microwave energy does not substantially affect any silicon or silica in the optical component 10 because silica and silicon are largely invisible to microwave energy. As a result, this method does not adversely affect the silicon or silica in the optical component 10.

FIG. 9E and FIG. 9F illustrate a method of converting the component 10 of FIG. 9D into a component 10 where each waveguide 12 is associated with a different thermal conductor 32. A mask 50 is formed on the regions of the component 10 where the thermal conductor 32 is to be formed as shown in FIG. 9E. An etch is performed on the exposed regions of the thermal conductor 32 and the mask 50 removed to provide the component 10 shown in FIG. 9F. A suitable etch includes, but is not limited to, a wet chemical etch or a dry etch. A suitable mask 50 includes, but is not limited to, a photoresist.

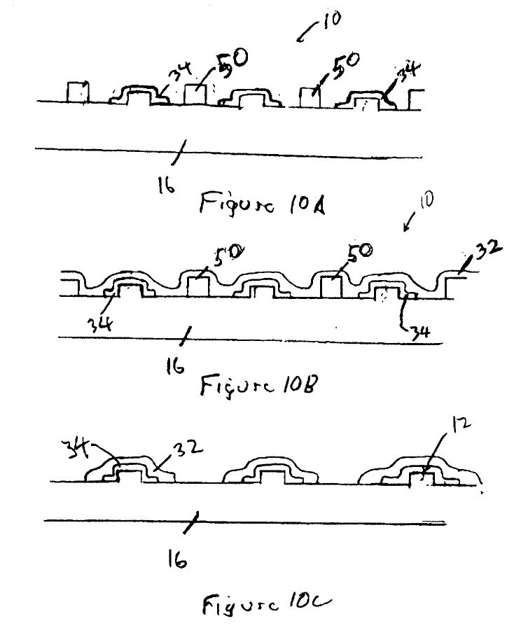

FIGS. 10A through FIG. 10C illustrate another embodiment of a method for forming a component 10 where each waveguide 12 is associated with a different thermal conductor 32. The method can be started with an optical component 10 such as the optical component 10 of FIG. 9C or FIG. 8B. A mask 50 is formed between the thermal insulators 34 as shown in FIG. 10A. A suitable mask 50 includes, but is not limited to, a photoresist. A thermal conductor 32 is formed over the component 10 as shown in FIG. 10B. A suitable thermal conductor 32 includes nanotubules. A suitable method for forming a thermal conductor 32 that includes nanotubules includes forming a layer of carbon over the component 10. The component 10 is then exposed to a level of microwaves sufficient to convert the carbon to one or more nanotubules. Unconverted carbon can optionally be removed from the component 10 so the nanotubules remain on the optical component 10. The component 10 can be placed in a mask 50 removing solution such as a photoresist solution to provide the optical component 10 of FIG. 10C.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An optical component, comprising:
a light signal carrying region positioned between secondary regions; and
a thermal conductor positioned over the light signal carrying region and at least a portion of the secondary regions, the thermal conductor including one or more nanotubules.

2. A method of forming an optical component, comprising:
forming an optical component having a light signal carrying region positioned between secondary regions; and
forming a thermal conductor over the light signal carrying region and at least a portion of the secondary regions, the thermal conductor including one or more nanotubules.

3. The method of claim 2, wherein forming the thermal conductor having one or more nanotubules includes applying microwaves to a material.

4. The method of claim 3, wherein the material to which the microwaves are applied is carbon.
